(19) United States
(12) Patent Application Publication
(10) Pub. No.: US 2021/0055670 A1
(43) Pub. Date: Feb. 25, 2021

(54) OPTICAL SCANNING DEVICE INCLUDING SYNCHRONIZATION DETECTION SENSOR AND ELECTROPHOTOGRAPHIC PRINTER INCLUDING THE SAME

(71) Applicant: HEWLETT-PACKARD DEVELOPMENT COMPANY, L.P., Spring, TX (US)

(72) Inventors: Sun Min KIM, Hwaseong-si (KR); Heon-Hee LIM, Suwon-si (KR)

(73) Assignee: HEWLETT-PACKARD DEVELOPMENT COMPANY, L.P., Spring, TX (US)

(21) Appl. No.: 16/958,329

(22) PCT Filed: Aug. 24, 2018
(86) PCT No.: PCT/KR2018/009776

§ 371 Date: Jun. 26, 2020

(30) Foreign Application Priority Data
Dec. 28, 2017 (KR) 10-2017-0182622

(51) Int. Cl. G03G 15/04; G03G 15/043; G02B 26/12

(52) U.S. Cl. CPC G03G 15/04036; G02B 26/125; G02B 26/123; G03G 15/0435

(57) ABSTRACT

An optical scanning device for an electrophotographic printer includes a light source that radiates a light beam and a light deflector that deflects the light beam radiated by the light source in a main scanning direction. The optical scanning device also includes a synchronization detection sensor having a sensing region that receives a portion of the light beam deflected by the light deflector. The sensing region has a greater length in the main scanning direction than in a sub-scanning direction.

### BACKGROUND ART

An electrophotographic printer prints an image by developing an electrostatic latent image on a photoconductor to form a visible toner image and transfers and fixes the toner image to a recording medium. The electrophotographic printer includes an optical scanning device which deflects light modulated in correspondence to image information in a main scanning direction and then scans the light onto the photo-conductor moving in a sub-scanning direction.

The optical scanning device includes optical elements, such as a collimating lens, a cylindrical lens, and an f-theta lens, to focus light radiated from a light source to a spot on the photoconductor. The optical scanning device includes a synchronization detection sensor for synchronization with the main scanning direction, i.e., for horizontal synchronization. The synchronization detection sensor receives some of the light deflected in the main scanning direction.

### BRIEF DESCRIPTION OF DRAWINGS

FIG. 1 is a perspective view of an example of an optical scanning device;

FIG. 2 is a diagram showing an optical path with respect to a sub-scanning direction in an example of the optical scanning device of FIG. 1;

FIG. 3 is a diagram showing an optical path with respect to a main scanning direction in an example of the optical scanning device of FIG. 1;

FIG. 4 is a diagram showing an optical path with respect to a main scanning direction in an example of an optical scanning device;

FIG. 5 is a schematic diagram of an example of a synchronization detection sensor;

FIG. 6 is a schematic diagram of an example of a structure for preventing an error from occurring in a horizontal synchronization signal due to diffusely reflected light;

FIG. 7 is a schematic diagram of an example of a structure for preventing an error from occurring in a horizontal synchronization signal due to diffusely reflected light;

FIG. 8 is a diagram of an example of a sub-scanning direction optical path in a synchronization detection light path;

FIG. 9 is a schematic plan view of an example of an optical scanning device; and

FIG. 10 is a schematic diagram of an example of an electrophotographic printer.

### MODE FOR THE INVENTION

An electrophotographic printer forms an electrostatic latent image on a surface of a photoconductor which has been charged, forms a visible toner image by applying toner to the electrostatic latent image, and transfers and fixes the toner image to a recording medium, thereby printing the image. The electrophotographic printer includes an optical scanning device which forms the electrostatic latent image on the photo-conductor, which has been charged with a uniform electric potential, by scanning modulated light according to image information.

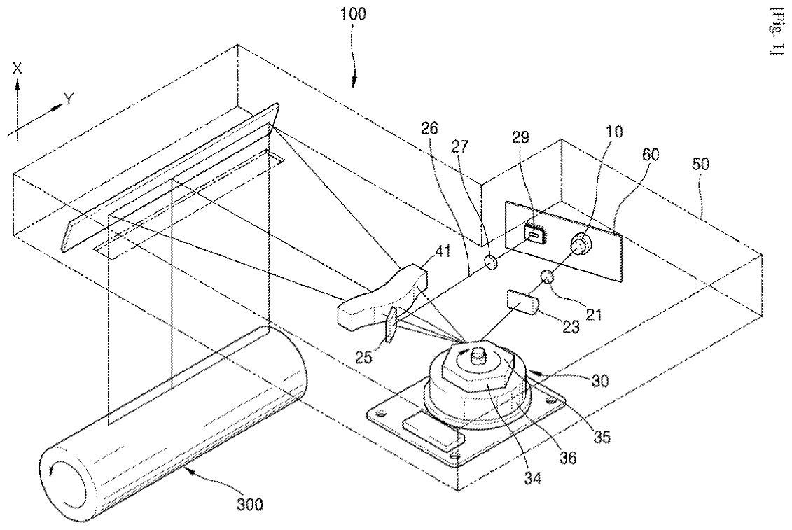

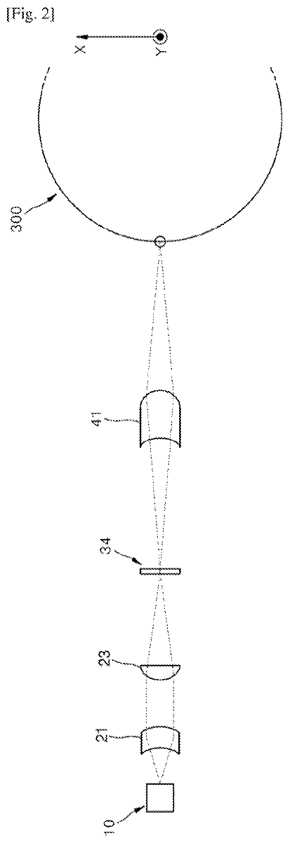

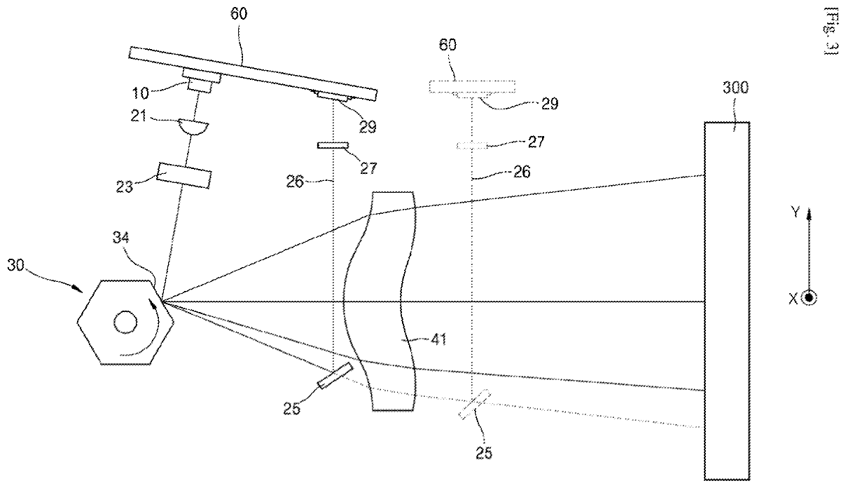

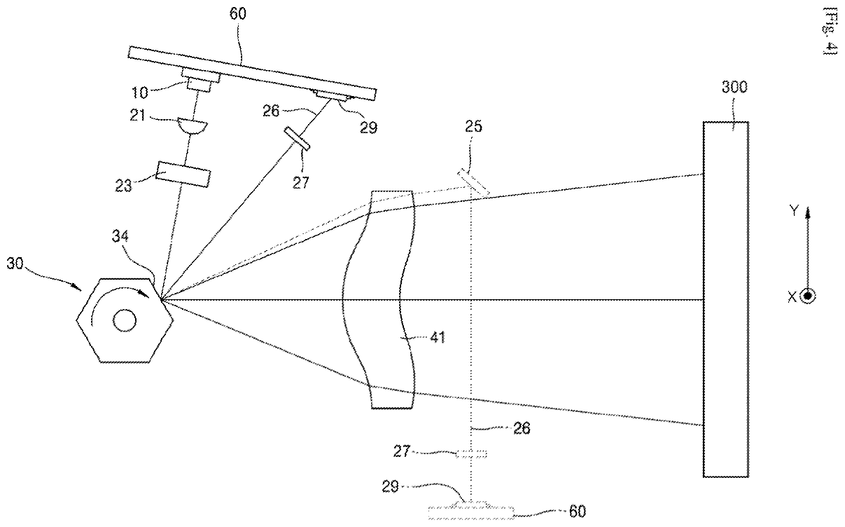

FIG. 1 is a perspective view of an example of an optical scanning device 100. FIG. 2 is a diagram showing an optical path with respect to a sub-scanning direction X in an example of the optical scanning device 100 of FIG. 1. FIG. 3 is a diagram showing an optical path with respect to a main scanning direction Y in an example of the optical scanning device 100 of FIG. 1. FIG. 4 is a diagram showing an optical path with respect to the main scanning direction Y in an example of the optical scanning device 100.

Referring to FIGS. 1 through 4, the optical scanning device 100 may include a light source 10 radiating a light beam and a light deflector 30 deflecting the light beam radiated from the light source 10 in the main scanning direction Y of an object-to-be-exposed, e.g., a photosensitive drum 300. Hereinafter, the photosensitive drum 300 is referred to as the object-to-be-exposed 300. The optical scanning device 100 may also include a synchronization detection sensor 29. The synchronization detection sensor 29 receives a portion of the light beam radiated from the light source 10 and generates a horizontal synchronization signal for horizontal synchronization of scanning lines (e.g., synchronization in the main scanning direction Y). The portion of the light beam deflected by the light deflector 30 branches off to form a synchronization detection light path 26. The synchronization detection sensor 29 receives a light beam traveling along the synchronization detection light path 26. The synchronization detection sensor 29 may be an optical sensor.

Hereinafter, in all light paths through which a light beam passes, the main scanning direction Y indicates a direction in which the light beam is deflected by the light deflector 30 and the sub-scanning direction X indicates a direction in which the object-to-be-exposed 300 is moved.

For example, a laser diode may be used as the light source 10. As an example of the light deflector 30, a polygon mirror 35 having a plurality of reflective surfaces 34 and a motor 36 rotating the polygon mirror 35 are illustrated in FIG. 1.

A collimating lens 21, which converts a light beam radiated from the light source 10 into parallel light, may be provided in an optical path between the light source 10 and the light deflector 30. An optical element 23 may be provided between the collimating lens 21 and the light deflector 30 to focus the light beam at each of the reflective surfaces 34 in the sub-scanning direction X. The optical element 23 may include, for example, at least one cylindrical lens.

The optical scanning device 100 may also include an imaging optical element 41 between the light deflector 30 and the object-to-be-exposed 300. The imaging optical element 41 scans the light beam deflected by the light deflector 30 onto a surface of the object-to-be-exposed 300 at a constant velocity to form an image. The imaging optical element 41 may include, for example, an f-theta lens. The f-theta lens may include at least one lens. The f-theta lens may perform compensation of the light beam, which has been deflected by the light deflector 30, with respect to the main scanning direction Y and the sub-scanning direction X at different magnifying powers, respectively, and image the compensated light beam on the object-to-he-exposed 300.

The synchronization detection sensor 29 may receive a portion of the light beam between the light deflector 30 and the imaging optical element 41. As shown by solid lines in FIG. 3, a portion of the light beam deflected by the light deflector 30 may be reflected by a reflective mirror 25 and incident on the synchronization detection sensor 29. As another example, as shown by solid lines in FIG. 4, a portion of the light beam deflected by the light deflector 30 may be directly incident on the synchronization detection sensor 29.

As another example, the synchronization detection sensor 29 may receive a portion of a light beam passing through the imaging optical element 41. As shown by dashed lines in FIGS. 3 and 4, a portion of a light beam, which has been deflected by the light deflector 30 and has passed through the imaging optical element 41, may be reflected by the reflective mirror 25 and incident on the synchronization detection sensor 29.

The synchronization detection sensor 29 may be manufactured as, for example, an integrated circuit (IC) chip and installed in a printed circuit board (PCB) 60. The synchronization detection sensor 29 may be, for example, a quad flat package (QFP) chip or a quad flat non-lead (QFN) package chip. The synchronization detection sensor 29 is installed in the PCB 60. Although not shown, the synchronization detection sensor 29 may be directly installed in a frame 50 and connected to the PCB 60 through a connection line which is not shown.

FIG. 5 is a schematic diagram of an example of the synchronization detection sensor 29. The synchronization detection sensor 29 is not shown in detail but is schematically illustrated in FIG. 5, which shows the function of the synchronization detection sensor 29. Referring to FIG. 5, the synchronization detection sensor 29 includes a sensing region 29-1 which receives a light beam LB. The light beam LB is directed by the light deflector 30 in the main scanning direction Y. When the light beam LB is incident on the sensing region 29-1, a horizontal synchronization signal for horizontal synchronization of scanning tines (e.g., synchronization in the main scanning direction Y) is generated. The sensing region 29-1 has a length LY in the main scanning direction Y and a length LX in the sub-scanning direction X. The length LY in the main scanning direction Y is greater than the length LX in the sub-scanning direction X.

Before the light beam LB is incident on the sensing region 29-1, the light beam LB may be reflected by the PCB 60 or circuit elements of the PCB 60. At this time, diffuse reflection may occur. The light beam LB may be diffusely reflected by a lead of the synchronization detection sensor 29. When diffusely reflected light is incident on the sensing region 29-1 before the light beam LB reaches the sensing region 29-1, an incorrect horizontal synchronization signal may be generated. In addition, when, after the light beam LB reaches the sensing region 29-1 and a horizontal synchronization signal is generated, the light beam LB, which has passed through the sensing region 29-1, is diffusely reflected and is incident again on the sensing region 29-1, an incorrect horizontal synchronization signal may be generated. An error in a horizontal synchronization signal may cause an error in vertical (e.g., the sub-scanning direction X) alignment of an image to be printed.

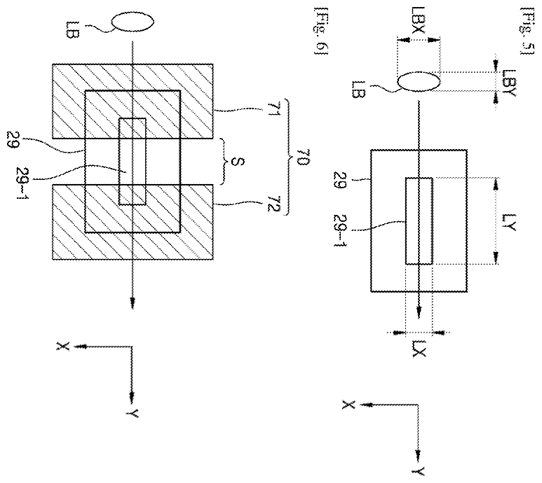

FIG. 6 is a schematic diagram of an example of a structure for preventing an error from occurring in a horizontal synchronization signal due to diffusely reflected light. Referring to FIG. 6, to manage an error occurring in a horizontal synchronization signal due to diffusely reflected light, a light blocking member 70 which blocks diffusely reflected light may be provided in at least one side of the sensing region 29-1 in the main scanning direction Y.

The light blocking member 70 may include a first light blocking member 71 at an upstream side of the sensing region 29-1 in the main scanning direction Y. The first light blocking member 71 may be implemented by a shading film (or tape) attached to the synchronization detection sensor 29. The first light blocking member 71 may be implemented by a shading film (or tape) attached to the PCB 60, in which the synchronization detection sensor 29 is installed, or across the PCB 60 and the synchronization detection sensor 29. The first light blocking member 71 may shield the lead of the synchronization detection sensor 29. The first light blocking member 71 may shield a portion of the sensing region 29-1.

The light blocking member 70 may also include a second light blocking member 72 at a downstream side of the sensing region 29-1 in the main scanning direction Y. The second light blocking member 72 may be separated from the first light blocking member 71 in the main scanning direction Y to form a slit S through which the light beam LB passes. The second light blocking member 72 may be implemented by a shading film (or tape). The shading film (or tape) may be attached to the synchronization detection sensor 29, the PCB 60 in which the synchronization detection sensor 29 is installed, or the like. The shading film (or tape) may be attached across the PCB 60 and the synchronization detection sensor 29. The second light blocking member 72 may shield the lead of the synchronization detection sensor 29. The second light blocking member 72 may shield a portion of the sensing region 29-1.

FIG. 7 is a schematic diagram of an example of a structure for preventing an error from occurring in a horizontal synchronization signal due to diffusely reflected light. Referring to FIG. 7, a light blocking member 70a may be implemented as a shading rib provided in the frame 50 which supports the light source 10, the light deflector 30, and the synchronization detection sensor 29. The shading rib may be integrally formed together with the frame 50 or may be manufactured as a separate member and assembled together with the frame 50. The shading rib may be positioned in at least one side of the sensing region 29-1 in the main scanning direction Y to block diffusely reflected light.

The light blocking member 70a may include a first shading rib 73 at the upstream side of the sensing region 29-1 in the main scanning direction Y. The first shading rib 73 may prevent the light beam LB from being incident on a portion of a lead of the synchronization detection sensor 29, the portion being at the upstream side of the sensing region 29-1. The first shading rib 73 may prevent the light beam LB from being incident on an upstream region of the PCB 60 adjacent to the synchronization detection sensor 29. The first shading rib 73 may shield a portion of the sensing region 29-1.

The light blocking member 70a may include a second shading rib 74 at the downstream side of the sensing region 29-1 in the main scanning direction Y. The second shading rib 74 may be separated from the first shading rib 73 in the main scanning direction Y to form the slit S through which the light beam LB passes.

The second shading rib 74 may prevent the light beam LB from being incident on a portion of a lead of the synchronization detection sensor 29, the portion being at the downstream side of the sensing region 29-1. The second shading rib 74 may prevent the light beam LB from being incident on a downstream region of the PCB 60 adjacent to the synchronization detection sensor 29. The second shading rib 74 may shield a portion of the sensing region 29-1.

The first and second shading ribs 73 and 74 may be separated in a traveling direction of the light beam LB. For example, as shown by a dashed shape in FIG. 7, the second shading rib 74 may be separated from the first shading rib 73 toward an upstream side in the traveling direction of the light beam LB. Although not shown, the second shading rib 74 may be separated from the first shading rib 73 toward a downstream side in the traveling direction of the light beam LB.

As shown by a dashed shape in FIG. 7, when a length of a sensing region 29-2 in the sub-scanning direction X is greater than a length of the sensing region 29-2 in the main scanning direction Y, a tolerance range of a position error of the synchronization detection sensor 29 with respect to the synchronization detection light path 26, along which the light beam LB travels, in the main scanning direction Y is very small. When the slit S is dislocated from the sensing region 29-2 in the main scanning direction Y due to a manufacturing error of the frame 50, an assembly error between the synchronization detection sensor 29 and the frame 50, deformation of a component due to a use environment, or the like, a horizontal synchronization signal may not be generated or may be incorrectly generated. Accordingly, precise assembly error management may be needed during the manufacture of the optical scanning device 100.

According to an example of the disclosure, when the length LY of the sensing region 29-1 in the main scanning direction Y is greater than the length LX of the sensing region 29-1 in the sub-scanning direction X, a relatively large tolerance range of the position error of the synchronization detection sensor 29 with respect to the synchronization detection light path 26, along which the light beam LB travels, in the main scanning direction Y may be secured. Accordingly, an error may be prevented from occurring in a horizontal synchronization signal due to a position error of the synchronization detection sensor 29 or the light blocking member 70a in the main scanning direction Y, which may occur during the manufacture of the optical scanning device 100, or deformation of a component due to a use environment, and a burden of assembly error management during the manufacture of the optical scanning device 100 may be decreased.

In addition, when the light blocking member 70 or 70a is used, an error may be prevented from occurring in a horizontal synchronization signal due to diffusely reflected light. The amount of jitter in a horizontal synchronization signal was measured at a variable voltage ranging from 0.5 V to 2.0 V, which is applied to the synchronization detection sensor 29. The allowable amount of jitter is, for example, 18 ns. In a structure according to the related art shown by the dashed shape in FIG. 7, the amount of jitter was about 20 ns at an upper limit of the variable voltage and was about 50 ns at a lower limit of the variable voltage. It is anticipated that there was an influence of diffusely reflected light. Contrarily, in the optical scanning device 100 according to an example of the disclosure, the amount of jitter was maintained at about 8 ns at the variable voltage ranging from the upper limit to the lower limit, and there was almost no influence of diffusely reflected light.

The light beam LB incident on the sensing region 29-1 may have greater optical power in the main scanning direction Y than in the sub-scanning direction X. Referring back to FIG. 5, the light beam LB incident on the sensing region 29-1 may have a sub-scanning direction length LBX which is greater than a main scanning direction length LBY. The main scanning direction length LBY of the light beam LB incident on the sensing region 29-1 may be equal to or less than a length of a light beam when the light beam is reflected by a reflective surface 34 of the light deflector 30. The sub-scanning direction length LBX of the light beam LB may be at least 1 mm.

When the light beam LB incident on the sensing region 29-1 has greater optical power in the main scanning direction Y than in the sub-scanning direction X, a relatively large tolerance range of the position error of the synchronization detection sensor 29 with respect to the synchronization detection light path 26, along which the light beam LB travels, in the sub-scanning direction X may be secured. Accordingly, an error may be prevented from occurring in a horizontal synchronization signal due to a position error of the synchronization detection sensor 29 in the sub-scanning direction X, which may occur during the manufacture of the optical scanning device 100, or deformation of a component due to a use environment, and the burden of assembly error management during the manufacture of the optical scanning device 100 may be decreased.

The optical scanning device 100 may also include a beam shaping member 27 which shapes the light beam LB, which is incident on the sensing region 29-1 among a light beam deflected by the light deflector 30, such that the sub-scanning direction length LBX is greater than the main scanning direction length LBY. The beam shaping member 27 is positioned in the synchronization detection light path 26. The beam shaping member 27 may be between the light deflector 30 and the synchronization detection sensor 29. The beam shaping member 27 may focus the light beam LB in the main scanning direction Y and expand the light beam LB in the sub-scanning direction X as much as the amount of light allows.

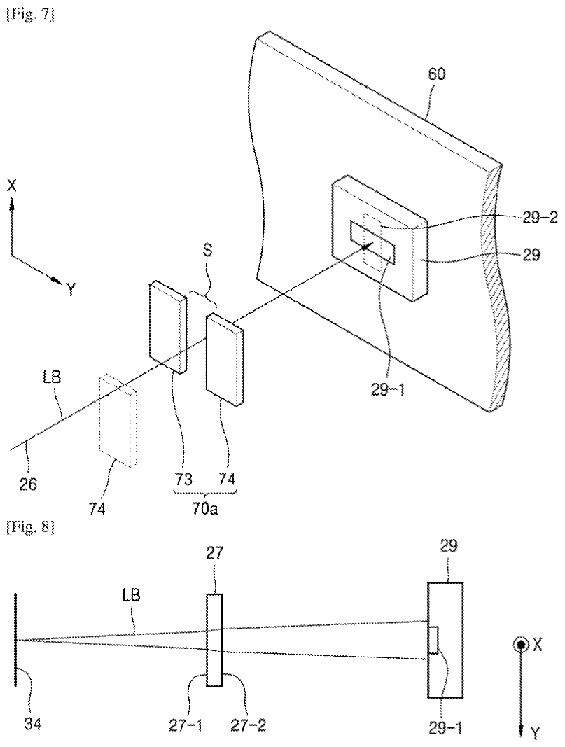

FIG. 8 is a diagram of an example of a sub-scanning direction optical path in the synchronization detection light path 26. Referring to FIG. 8, the beam shaping member 27 includes an entry surface 27-1 and an exit surface 27-2. At least one of the entry surface 27-1 and the exit surface 27-2 may be cylindrical.

For example, the entry surface 27-1 may be flat and the exit surface 27-2 may be cylindrical. When the radius of curvature of a cylindrical surface is 30 mm, the light beam LB may form an image having the main scanning direction length LBY of 50 mm and the sub-scanning direction length LBX of 1700 mm in the sensing region 29-1. As another example, the entry surface 27-1 may be cylindrical and the exit surface 27-2 may be flat. As another example, both the entry surface 27-1 and the exit surface 27-2 may be cylindrical. In this case, the radius of curvature of the entry surface 27-1 and the exit surface 27-2 may be determined such that the sub-scanning direction length LBX has an appropriate value.

At least one of the entry surface 27-1 and the exit surface 27-2 may be spherical. In this case, lens power of the beam shaping member 27 in the main scanning direction Y may be greater than lens power of the beam shaping member 27 in the sub-scanning direction X.

For example, the entry surface 27-1 and the exit surface 27-2 may be a combination of a cylindrical surface and a spherical surface. The radius of curvature may vary with the position of the beam shaping member 27. For example, when the entry surface 27-1 is cylindrical with a radius of curvature of 35 mm in the main scanning direction Y and the exit surface 27-2 is spherical with a radius of curvature of −100 mm, the light beam LB may form an image having the main scanning direction length LBY of 42 mm and the sub-scanning direction length LBX of 1610 mm in the sensing region 29-1.

At least one of the entry surface 27-1 and the exit surface 27-2 may be a curved surface that has greater lens power in the main scanning direction Y than in the sub-scanning direction X. For example, when the entry surface 27-1 is cylindrical with a radius of curvature of 35 mm in the main scanning direction Y and the exit surface 27-2 is curved with a radius of curvature of −100 mm in the main scanning direction Y and a radius of curvature of −80 mm in the sub-scanning direction X, the light beam LB may form an image having the main scanning direction length LBY of 42 mm and the sub-scanning direction length LBX of 1220 mm in the sensing region 29-1.

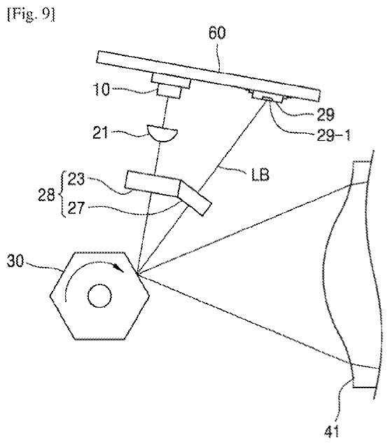

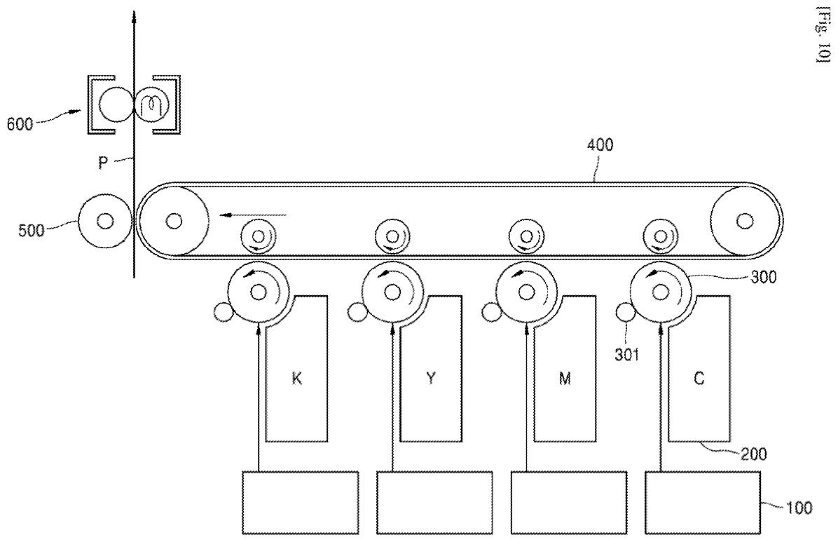

FIG. 9 is a schematic plan view of an example of the optical scanning device 100. Referring to FIG. 9, when the optical element 23 is close to the beam shaping member 27, for example, when the synchronization detection sensor 29 receives a portion of a light beam between the light deflector 30 and the imaging optical element 41, the optical element 23 and the beam shaping member 27 may be integrally formed as a lens 28.

FIG. 10 is a schematic diagram of an example of an electrophotographic printer. Referring to FIG. 10, the photosensitive drum 300, a charging roller 301, the optical scanning device 100, a developing device 200, an intermediate transfer belt 400, a transfer roller 500, and a fuser 600 are shown.

The photosensitive drum 300 is an example of a photoconductor and is implemented by forming a photosensitive layer on an outer circumferential surface of a cylindrical metal pipe to have a predetermined thickness. As another example, a photosensitive belt may be used as the photoconductor. The charging roller 301 is in contact with the photosensitive drum 300 and rotates. The charging roller 301 is an example of a charger which charges a surface of the photosensitive drum 300 to a uniform electric potential. A charging bias voltage is applied to the charging roller 301. Instead of the charging roller 301, a corona charger (not shown) may be used. The optical scanning device 100 scans a light beam, which has been modulated corresponding to image information, onto the photosensitive drum 300, which has been charged to have a uniform potential, thereby forming an electrostatic latent image. The device illustrated in FIGS. 1 through 9 may be used as the optical scanning device 100.

Toner is accommodated in the developing device 200. The toner is moved to the photosensitive drum 300 by a developing bias voltage applied between the developing device 200 and the photosensitive drum 300 to develop the electrostatic latent image into a toner image. The toner image formed on the photosensitive drum 300 is transferred to the intermediate transfer belt 400. The toner image is transferred to a printing medium P, which is fed between the transfer roller 500 and the intermediate transfer belt 400, by a transfer bias voltage. The toner image transferred to the printing medium P is fused and fixed on the printing medium P due to heat and pressure from the fuser 600, so that image forming is completed.

To print a color image, electrostatic latent images respectively corresponding cyan (C) image information, magenta (M) image information, yellow (Y) image information, and black (K) image information are formed on four photosensitive drums 300C, 300M, 300Y, and 300K, respectively. Four developing devices 200C, 200M, 200Y, and 200K provide C toner, M toner, Y toner, and K toner, respectively, to the photosensitive drums 300C, 300M, 300Y, and 300K, respectively, to form a C toner image, an M toner image, a Y toner image, and a K toner image, respectively. The C, M, Y, and K toner images are superposedly transferred to the intermediate transfer belt 400 and then to the printing medium P.

While examples have been described with reference to the drawings, it will be understood that various changes in form and details may be made therein without departing from the spirit and scope as defined by the following claims.

1. An optical scanning device for an electrophotographic printer, the optical scanning device comprising:
a light source to radiate a light beam;
a light deflector to deflect the light beam in a main scanning direction; and
a synchronization detection sensor having a sensing region to receive a portion of the light beam deflected by the light deflector, a length of the sensing region in the main scanning direction being greater than a length of the sensing region in a sub-scanning direction.

2. The optical scanning device of claim 1, further comprising a light blocking member, provided on at least one side of the sensing region in the main scanning direction, to block diffusely reflected light.

3. The optical scanning device of claim 2, wherein the light blocking member comprises a first light blocking member and a second light blocking member spaced apart from one another in the main scanning direction to form a slit through which the light beam passes for the portion of the light beam to be incident on the sensing region.

4. The optical scanning device of claim 2, further comprising a frame to support the light source, the light deflector, and the synchronization detection sensor,
wherein the light blocking member comprises a shading rib supported by the frame.

5. The optical scanning device of claim 4, wherein the shading rib comprises a first shading rib and a second shading rib spaced apart from one another in the main scanning direction to form a slit through which the light beam passes for the portion of the light beam to be incident on the sensing region.

6. The optical scanning device of claim 5, wherein the first shading rib and the second shading rib are spaced apart from one another in a traveling direction of the light beam.

7. The optical scanning device of claim 1, wherein the light beam deflected by the light deflector and traveling toward the sensing region has a greater length in the sub-scanning direction than in the main scanning direction.

8. The optical scanning device of claim 7, further comprising a beam shaping member to shape the light beam deflected by the light deflector to have the greater length in the sub-scanning direction than in the main scanning direction, the portion of the light beam being received by the sensing region after being deflected by the light deflector and shaped by the beam shaping member.

9. The optical scanning device of claim 8, wherein
the beam shaping member includes an entry surface and an exit surface, and
at least one of the entry surface and the exit surface has a cylindrical surface having a lens power in the sub-scanning direction, a spherical surface, or a curved surface having a greater lens power in the main scanning direction than in the sub-scanning direction.

10. The optical scanning device of claim 8, further comprising an optical element, provided between the light source and the light deflector, to focus the light beam radiated from the light source to a reflective surface of the light deflector,
wherein the beam shaping member and the optical element are integrally formed together.

11. The optical scanning device of claim 1, wherein the portion of the light beam received by the sensing region has a greater optical power in the main scanning direction than in the sub-scanning direction.

12. An electrophotographic printer, comprising:
a photoconductor; and
an optical scanning device to form an electrostatic latent image by scanning light onto the photoconductor, the light being modulated according to image information, the optical scanning device including:
a light source to radiate a light beam,
a light deflector to deflect the light beam in a main scanning direction, and
a synchronization detection sensor having a sensing region to receive a portion of the light beam deflected by the light deflector, a length of the sensing region in the main scanning direction being greater than a length of the sensing region in a sub-scanning direction.

13. The electrophotographic printer of claim 12, further comprising a first light blocking member and a second light blocking member spaced apart from one another in the main scanning direction to form a slit through which the light beam passes for the portion of the light beam to be incident on the sensing region.

14. The electrophotographic printer of claim 13, further comprising a beam shaping member, provided along a path of the light beam between the light deflector and the synchronization detection sensor, to shape the light beam deflected by the light deflector to have a greater length in the sub-scanning direction than in the main scanning direction.

15. The electrophotographic printer of claim 14, wherein
the beam shaping member includes an entry surface and an exit surface, and
at least one of the entry surface and the exit surface has a cylindrical surface having a lens power in the sub-scanning direction, a spherical surface, or a curved surface having a greater lens power in the main scanning direction than in the sub-scanning direction.
